(19) United States
(12) Patent Application Publication
(10) Pub. No.: US 2019/0375140 A1
(43) Pub. Date: Dec. 12, 2019

(54) MOLDED PLASTIC PARTS HAVING A CLEAR OR TRANSLUCENT OVERMOLD AND A SUBSTRATE

(71) Applicant: Otto A. Herrmann, Albuquerque, NM (US)

(72) Inventor: Otto A. Herrmann, Albuquerque, NM (US)

(21) Appl. No.: 16/438,218

(22) Filed: Jun. 11, 2019

Related U.S. Application Data
(60) Provisional application No. 62/683,629, filed on Jun. 11, 2018.

(51) Int. Cl. B29C 45/14; B29C 45/00; B32B 27/08

(52) U.S. Cl. CPC B29C 45/14811; B29K 2101/12; B32B 27/08; B29C 45/006

(57) ABSTRACT

A molded plastic part having a clear or translucent overmold and a substrate typically has a hard plastic substrate that can be opaque, translucent, or clear. The overmold is clear or translucent. Careful selection of materials provides for a substrate that retains its form after the thermoplastic overmold material, hot enough to flow, flows into the mold. A smooth area on the substrate provides a position for placing artwork.

### CROSS REFERENCE TO RELATED APPLICATION

This patent application claims the priority and benefit of U.S. Provisional Patent Application 62/683,629 filed Jun. 11, 2018 and titled “MOLDED PLASTIC PARTS HAVING A CLEAR OR TRANSLUCENT OVERMOLD AND A SUBSTRATE”. U.S. Provisional Patent 62/683,629 is herein incorporated by reference in its entirety.

### TECHNICAL FIELD

Embodiments relate to the fields of molding plastics, molded plastic items, handles, grips, ornaments, containers, decorations, grips for sporting goods, grips for firearms, and other grips.

### BACKGROUND

Plastic parts, particularly handles, tool grips, grips for sporting goods, grips for firearms, and other grips have been molded by flowing thermoplastic material into a mold. Most such devices are solid throughout and formed as a single piece of one type of hard plastic typically having a Shore hardness of 50D or more. Some plastic parts are formed of a softer plastic having a Shore hardness 70A or less. The softer plastic parts have a rubbery feel and can be more comfortable to hold.

Those practiced in the art of injection molding realize that Shore hardness ranges from 30A to 90D where 30A is the softest and 90D is the hardest. Injection molding can produce plastic parts from plastics within the range of Shore 30A to Shore 90D. Specifically, Shore A ranges from 30A to 100A with 30A being the softest and 100A being the hardest in that range. Shore D ranges from 15D to 90D with 15D being the softest and 90D being the hardest in that range. Shore 100A and 55D have roughly equivalent hardness.

There are also plastic parts formed of two parts: a substrate and an overmold. The substrate is typically a hard plastic while the overmold is a soft plastic. The plastic parts having a hard plastic substrate and a soft plastic overmold are also formed as a single piece because the overmold is formed by flowing plastic into a mold containing the substrate, thereby forming a single piece formed from two plastics each having a different hardness.

U.S. Pat. No. 9,234,721 titled “Cone Grip For Handgun” issued Jan. 12, 2016 and discloses a firearm grip having a substrate and an overmold. It is for its teachings of substrates, overmolds, molding, firearm grips, and other matters that U.S. Pat. No. 9,234,721 is incorporated herein by reference in its entirety.

U.S. Pat. No. 9,448,030 titled “Grip/Cover for Key Lock System” issued Sep. 20, 2016 and discloses covers for mounting systems such as key lock mounting systems having a substrate and an overmold. It is for its teachings of substrates, overmolds, molding, firearm accessories, and other matters that U.S. Pat. No. 9,448,030 is incorporated herein by reference in its entirety.

Those practiced in the art of plastic part production realize that a wide variety of handles, such as paint brush handles and other tool handles, can be formed as a substrate and an overmold.

The prior art plastic parts are typically not decorative and require new molds whenever a logo or decoration is to be changed. Systems and methods for producing decorative or branded plastic parts using fewer molds are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

Systems and methods are needed for molded plastic parts having a substrate and a clear (transparent) or translucent overmold. The overmold is formed from a first plastic and the substrate is formed from a second plastic. In general, the first plastic and the second plastic are thermoplastics such as thermoplastic elastomers. The substrate can be formed by flowing the second plastic into a first mold (also known as a substrate mold) and then allowing the second plastic to harden. The substrate can then be positioned in a second mold (also known as an overmold mold). The first plastic can then be flowed into the second mold to thereby form the overmold of the resulting molded plastic part. The molded plastic part is unitary because molding the first plastic onto the substrate forms a single part composed of two different plastics. Those practiced in the art of plastic molding are familiar with the selection of the first and second plastics such that the substrate is not deformed or melted by the first plastic when the first plastic flows into the mold and cools.

As described herein, an overmold is the portion of a molded plastic part that is formed by flowing a first plastic into a mold containing a substrate, the substrate also being a portion of the molded plastic part.

It is an aspect of the embodiments that the overmold can be transparent or can be translucent. Suitable materials include Santoprene, certain thermoplastic vulcanates and similar transparent or translucent thermoplastic elastomers. Numerous transparent thermoplastics are known in the art although they are generally hard plastics (e.g., Shore hardness 50D or more). Molded plastic parts that are rigid but with a soft grip can be formed using a hard plastic substrate (e.g., Shore hardness 50D or harder) and a soft plastic overmold (Shore hardness of 70A or softer). A hard material, as described herein, has a Shore hardness of 50D or is harder. A soft material, as described herein, has a Shore hardness of 70A or is softer. Through experimentation with and use of overmolded plastic parts, these shore hardness values have been determined to provide a subjectively pleasing feel.

In further testing, a soft range has been determined to be the range Shore 30A-90A and a hard range has been determined to be the range 30D-90D. It should be noted that the hardest plastic in the soft range (Shore 90A) is harder than the softest plastic in the hard range (Shore 30D). It is well understood materials of different hardness are compared, one will be harder than the other. It is therefor understood that a soft overmold on a hard substrate indicates that the hardness of the substrate is in the hard range (Shore 30D-90D), the hardness of the overmold is in the soft range (Shore 30A-90A) and that the overmold is softer than the substrate. Similarly, a hard overmold on a soft substrate indicates that the hardness of the overmold is in the hard range (Shore 30D-90D), the hardness of the substrate is in the soft range (Shore 30A-90A) and that the overmold is harder than the substrate. A soft overmold on a soft substrate indicates that the hardness of the overmold is in the soft range (Shore 30A-90A) and the hardness of the substrate is in the soft range (Shore 30A-90A). A hard overmold on a hard substrate indicates that the hardness of the overmold is in the hard range (Shore 30D-90D) and the hardness of the substrate is in the hard range (Shore 30D-90D).

Regardless of which material is harder and whether the substrate is harder or softer than the overmold, the method of production is that the substrate is placed in a mod and the overmold material is melted and flowed into mold to thereby cover and bind to at least part of the substrate.

It is another aspect of the embodiments that the substrate can be clear, translucent, or opaque. A graphic can be fixed to the substrate such that the graphic remains in its original position as the first plastic, the overmold material, is flowed over the substrate and the graphic. As such, a plastic part having an embedded graphic is formed. The graphic can be a trademarked logo, merely decorative, etc. The substrate can have a smooth area such that graphics, (e.g. decals, stamps, labels, stickers, etc.) can be easily set in place on the smooth area. Other areas of the substrate can be textured or patterned.

It is yet another aspect of the embodiments that the plastic part can have two sides, such as a left side and a right side. For example, many handles or grips designed to fit in the hand can refer to one side of the grip as the left side and refer to the opposing side of the grip as the right side. Different sides of a plastic part can have different textures. For example, the right side of a grip can be textured or patterned while the left side is smooth.

Recalling the embedded graphic discussed above, the overmold area over the graphic can be smooth to thereby improve the view of the graphic. Other parts of the overmold can be textured. For example, a grip can have a graphic embedded in the right side, textured overmold on the left side, and smooth overmold on the right side directly over the graphic.

It is a further aspect of the embodiments that the substrate and overmold are both transparent, in which case an embedded graphic would appear to float within the molded plastic part.

The graphic described herein can be a decal, a stamp, a label, a sticker, a business card, or another object such that the molded plastic part incorporates a two-dimensional artwork. An alternative embodiment has a three-dimensional object fixed to the substrate before the overmold is formed, thereby producing a molded plastic part incorporating a three-dimensional object. Such a molded plastic part need not incorporate a two-dimensional artwork.

It is a still yet further aspect of the embodiments to obtain a first plastic and to obtain a substrate that is positioned within an overmold mold. The substrate can be formed from a second plastic. Flowing the first plastic into the overmold mold produces an overmold on the substrate. As such, a molded plastic part is formed that is a unitary piece incorporating the substrate and the overmold. The piece is unitary because the substrate material and the overmold material bind to one another at a molecular level.

It is still yet another aspect of the embodiments that the overmold and the substrate can be homogenous. A homogenous item or material has uniform composition and properties throughout. Homogeneity is an aspect that can naturally occur during a molding process when the plastic is melted and flowed into a mold.

### BRIEF DESCRIPTION OF THE DRAWINGS

The accompanying figures, in which like names (reference numerals in utility) refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a substrate for a molded plastic part in accordance with aspects of the embodiments;

FIG. 2 illustrates a molded plastic part in accordance with aspects of the embodiments;

FIG. 3 illustrates the overmold portion of a molded plastic part in accordance with aspects of the embodiments;

FIG. 4 illustrates a decal being fixed to a substrate in accordance with aspects of the embodiments;

FIG. 5 illustrates a decal on a substrate in accordance with aspects of the embodiments;

FIG. 6 illustrates a molded plastic part with a translucent overmold and a graphic in accordance with aspects of the embodiments;

FIG. 7 illustrates a coin attached to a substrate in accordance with aspects of the embodiments;

FIG. 8 illustrates a molded plastic part with a translucent overmold and an embedded three-dimensional object in accordance with aspects of the embodiments;

FIG. 9 illustrates a substrate with a divot in accordance with aspects of the embodiments;

FIG. 10 illustrates a molded plastic part having a textured translucent overmold with a clear area directly over a graphic in accordance with aspects of the embodiments;

FIG. 11 illustrates a molded plastic part having a translucent overmold that is textured on a first side and that is smooth on a second side in accordance with aspects of the embodiments;

FIG. 12 illustrates a molded plastic part with a translucent overmold and a patterned substrate having a smooth area to which a graphic is fixed in accordance with aspects of the embodiments;

FIG. 13 illustrates a method of forming a molded plastic part in accordance with aspects of the embodiments; and

FIG. 14 illustrates a method for forming a molded plastic part in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

A molded plastic part having a clear or translucent overmold and a substrate can include a hard plastic substrate that can be opaque, translucent, or clear. The overmold can be clear or translucent. Careful selection of materials can provide for a substrate that retains its form after the thermoplastic overmold material, hot enough to flow, flows into the mold. A smooth area on the substrate can provide a position for placing artwork.

FIG. 1 illustrates a substrate 101 for a molded plastic part in accordance with aspects of the embodiments. The illustrated substrate can be a rod. In practice, the substrates are more complex. A rod can be used here for ease of illustration and understanding.

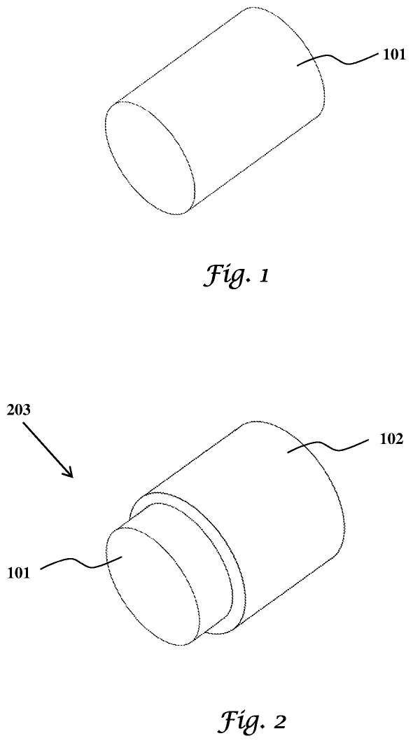

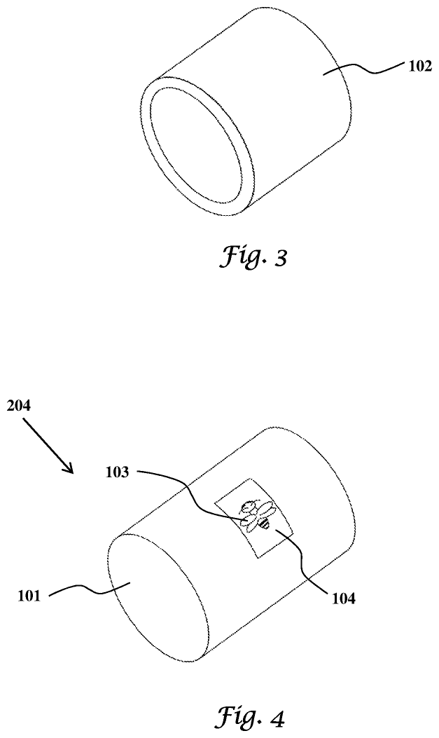

FIG. 2 illustrates a molded plastic part 203 in accordance with aspects of the embodiments. The molded plastic part 203 can include a substrate 101 and an overmold 102. FIG. 3 illustrates the overmold 102 of the molded plastic part 203 of FIG. 2.

FIG. 4 illustrates a decal 103 being fixed to a substrate 101 in accordance with aspects of the embodiments. Here, the decal 103 can be provided on a backing 104. Such decals can be fix to substrates by pressing the decal 103 against the substrate 101 and then removing the backing 104. The decal 103 remains on the substrate 101. Element 204 of FIG. 4 can include a substrate 101 with the backing 104 and decal 103 pressed to the substrate 101.

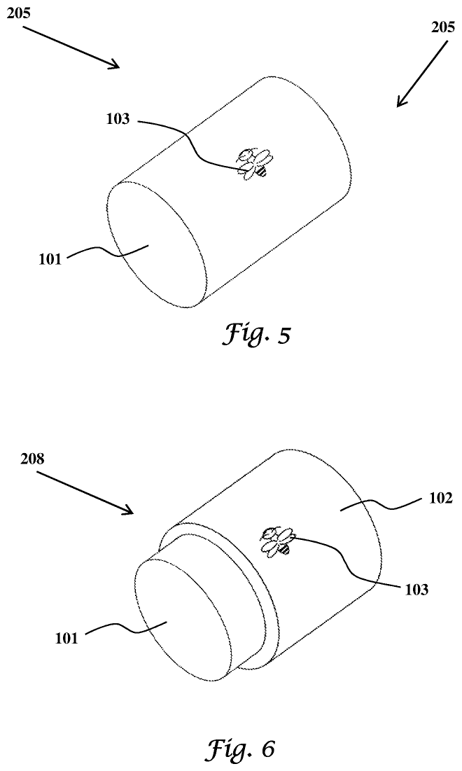

FIG. 5 illustrates a decal 103 on a substrate 101 in accordance with aspects of the embodiments. Element 205 of FIG. 5 is the same as element 204 of FIG. 4 with the backing 104 removed.

FIG. 6 illustrates a molded plastic part 208 with a translucent overmold 102 and a graphic 103 in accordance with aspects of the embodiments. Here, the overmold 102 has been formed on the substrate 101 and decal 103 shown in FIG. 5.

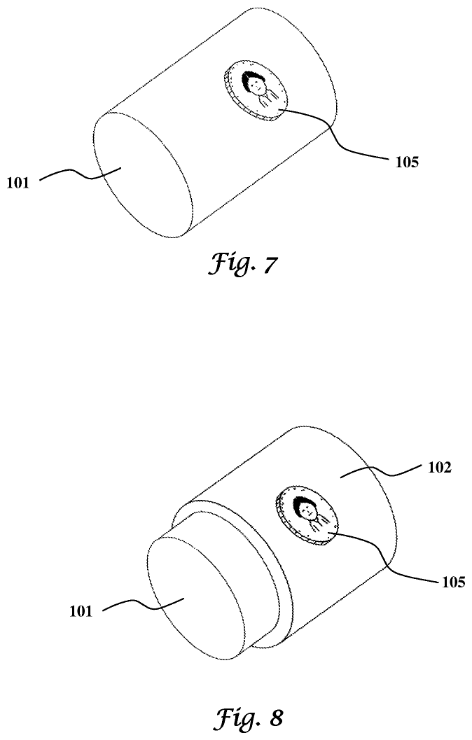

FIG. 7 illustrates a coin 105 attached to a substrate 101 in accordance with aspects of the embodiments. The coin 103 can be attached to the substrate 101 with and adhesive. An important factor is that the coin 105 remain in place as overmold material is flowed over the coin 105 and substrate 101. Here, the coin 105 is an example of a three-dimensional object. Other three-dimensional objects such as figurines, gems, badges, medals, models, etc. can be attached to the substrate 101.

FIG. 8 illustrates a molded plastic part with a translucent overmold 102 and an embedded three-dimensional object 105 in accordance with aspects of the embodiments. Here, the overmold 102 has been formed on the substrate 101 and coin 105 shown in FIG. 7.

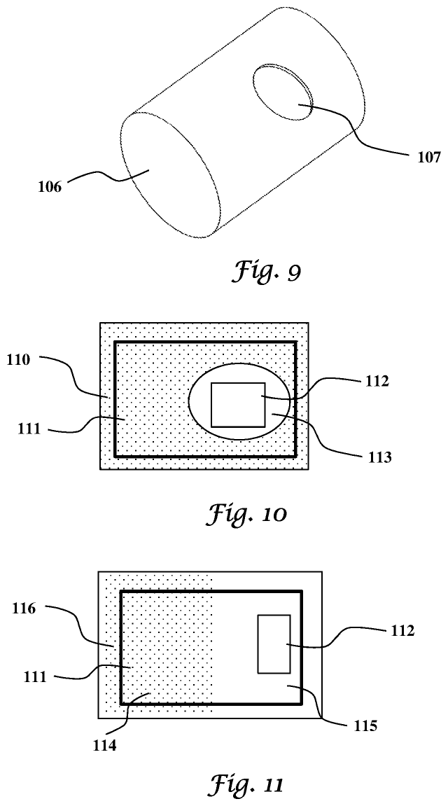

FIG. 9 illustrates a substrate 106 with a divot 107 in accordance with aspects of the embodiments. The coin 105 can be fixed to substrate 106 by pressing it into the divot 107. In general, a substrate can be formed or modified to have a divot. The divot can be sized for the object to be fixed to the substrate. In some embodiments, the object can be heated and pressed into the substrate to form the divot and to fix the object in place. In another example, badges for sports teams can all be the same size such that any of the badges can be fixed in place by being pressed into a divot sized for all the badges.

FIG. 10 illustrates a molded plastic part having a textured translucent overmold 110 with a clear area 113 directly over a graphic 112 in accordance with aspects of the embodiments. The graphic 112 is on substrate 111 that is covered by overmold 110.

FIG. 11 illustrates a molded plastic part having a translucent overmold 116 that is textured on a first side 114 and that is smooth on a second side 115 in accordance with aspects of the embodiments.

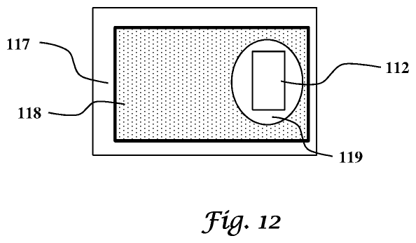

FIG. 12 illustrates a molded plastic part with a translucent overmold 117 and a patterned substrate 118 having a smooth area 119 to which a graphic 112 can be fixed in accordance with aspects of the embodiments.

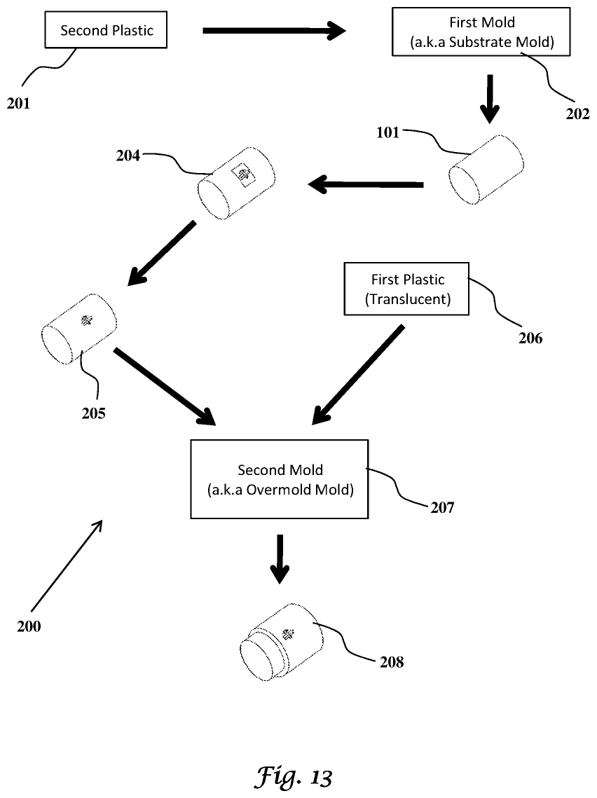

FIG. 13 illustrates a method 200 of forming a molded plastic part in accordance with aspects of the embodiments. The second plastic 201 can be flowed into the first mold 202 to produce a substrate 101. The substrate with decal and backing 204 can be produced and then the backing removed 205. The substrate with decal 205 can be positioned in the second mold 207. The first plastic 206, which is translucent, can be flowed into the second mold 207 to produce a molded plastic part 208 having a translucent overmold and a visible graphic.

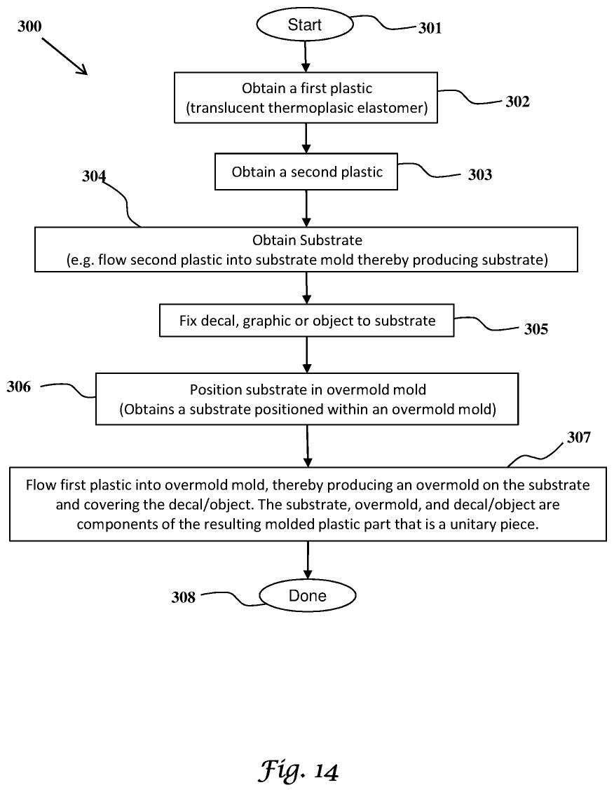

FIG. 14 illustrates a method 300 for forming a molded plastic part in accordance with aspects of the embodiments. As shown at block 301, the process can begin. Thereafter, as depicted at block 302, a first plastic can be obtained and as shown next at block 303, a second plastic can be obtained. As illustrated next at block 304, a substrate can be obtained. The substrate can be formed by flowing the second plastic into a substrate mold. Alternatively, the substrate can be obtained separately by, for example, purchasing it from a supplier, in which case the second plastic is obtained in the form of an already formed substrate. As shown next at block 305, a decal, a graphic, or an object can be fixed to the substrate. The substrate can then be positioned in the overmold mold as illustrated at block 306 to obtain a substrate positioned within an overmold mold. Flowing the first plastic into the overmold mold can produce an overmold on the substrate and covering of the graphic/decal/object as shown at block 307. The resulting molded plastic part is a unitary piece including the substrate and the overmold. The graphic, decal, or object can also be included within the molded plastic part. The molded plastic part having been formed, the process can be then completed as depicted at block 308.

Note that the functions, steps or operations noted in the various blocks illustrated and discussed herein may occur out of the order noted in the figures. For example, two blocks shown in succession may, in fact, be executed substantially concurrently, or the blocks may sometimes be executed in the reverse order, depending upon the functionality involved.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A molded plastic part, comprising:
an overmold comprising a first plastic wherein the overmold is homogenous; and
a substrate comprising a second plastic;
wherein the molded plastic part is a unitary piece, and wherein the overmold is fixed in place on the substrate, and wherein the overmold is translucent or clear.

2. The molded plastic part of claim 1 wherein the second plastic is at least as hard as a material having a Shore hardness of 30D.

3. The molded plastic part of claim 2 wherein the first plastic is at least as soft as a material having a Shore hardness of 90A.

4. The molded plastic part of claim 1 wherein the substrate is opaque.

5. The molded plastic part of claim 1 further comprising a graphic wherein the graphic is disposed on the substrate and covered by the overmold.

6. The molded plastic part of claim 1 further comprising a graphic wherein the substrate comprises a smooth area and wherein the graphic is disposed on the smooth area and covered by the overmold.

7. The molded plastic part of claim 6 wherein the overmold comprises a smooth area disposed directly over the graphic.

8. The molded plastic part of claim 1 wherein the molded plastic part comprises a left side and a right side and wherein the overmold is textured on the right side and smooth on the left side.

9. The molded plastic part of claim 1 wherein the molded plastic part comprises a left side and a right side and wherein the overmold is textured on the left side and smooth on the right side.

10. The molded plastic part of claim 1 wherein the substrate and the overmold are transparent.

11. The molded plastic part of claim 1 wherein the substrate is opaque and the overmold is translucent.

12. A molded plastic part, comprising:
an overmold comprising a first plastic, wherein the overmold is homogenous;
a substrate comprising a second plastic; and
an object;
wherein the overmold is formed to produce a unitary piece with the substrate, wherein the overmold is transparent, wherein the graphic object is disposed on the substrate and covered by the overmold, wherein the second plastic is at least as hard as a material having a Shore hardness of 30D, wherein the first plastic is at least as soft as a material having a Shore hardness of 90A, wherein the substrate is transparent.

13. A method, comprising:
obtaining a first plastic;
obtaining a substrate that is positioned within an overmold mold, the substrate comprising a second plastic;
flowing the first plastic into the overmold mold to produce an overmold on the substrate, wherein a molded plastic part comprises the overmold and the substrate, wherein the molded plastic part is a unitary piece, and wherein the overmold is translucent.

14. The method of claim 13 wherein the second plastic is at least as hard as a material having a Shore hardness of 50D.

15. The method of claim 13 wherein the first plastic is at least as soft as a material having a Shore hardness of 70A.

16. The method of claim 13 wherein the substrate is opaque.

17. The method of claim 13 further comprising fixing a graphic on the substrate before flowing the first plastic into the mold such that the molded plastic part comprises the graphic wherein the graphic is covered by the overmold.

18. The method of claim 17 wherein the substrate comprises a smooth area and wherein the graphic is disposed on the smooth area and covered by the overmold.

19. The method of claim 17 wherein the overmold comprises a smooth area disposed directly over the graphic.

20. The method of claim 13 wherein the molded plastic part comprises a first side and a second side and wherein the overmold is textured on the first side and smooth on the second side.
